(19) United States
(12) Patent Application Publication
(10) Pub. No.: US 2010/0245900 A1
(43) Pub. Date: Sep. 30, 2010

(54) IMAGE FORMING APPARATUS AND COMPUTER-READABLE STORAGE MEDIUM FOR COMPUTER PROGRAM

(75) Inventor: Tsuyoshi Morimoto, Itami-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/712,258

(22) Filed: Feb. 25, 2010

(30) Foreign Application Priority Data
Mar. 25, 2009 (JP) 2009-075249

(51) Int. Cl. G06K 15/00

(52) U.S. Cl. 358/1.15; 358/1.16

(57) ABSTRACT

A Multi-Function Peripheral (MFP) is provided with a locked mailbox bin. The MFP receives a print job, calculates a print quantity for a case in which the received print job is executed. If the calculated print quantity for the print job is more than a predetermined quantity, the MFP executes printing based on the print job with the locked mailbox bin designated as an output destination of a printed material. If the calculated print quantity for the print job is equal to or less than the predetermined quantity, the MFP stores the print job in a storage portion.

This application is based on Japanese patent application No. 2009-075249 filed on Mar. 25, 2009, the contents of which are hereby incorporated by reference.

### BACKGROUND OF THE INVENTION

1. Field of the Invention

The present invention relates to secure printing performed by an image forming apparatus.

2. Description of the Related Art

In recent years, there has been provided a Multi-Function Peripheral (MFP) that prompts a user to enter authentication information such as a password, starts printing a document of the user, and outputs the document only when the authentication information entered by the user is verified.

For example, a user enters a password through an operational panel or the like provided in an MFP, and the password is verified; thereby the user is permitted to start printing, for example, a document of the user.

There has also been provided an MFP that ensures the security of a printed material such as a document by outputting the printed material to a locked (lockable) mailbox bin. The locked mailbox bin is configured to be electronically locked, which prevents somebody else from carrying away a printed material contained therein.

For example, the MFP prints a document in advance and outputs the document to a locked mailbox bin. After that, when a user enters a password through an operational panel or the like provided in the MFP and the password is verified, an electronic lock on the locked mailbox bin to which the document of the user has been outputted is unlocked.

In this way, in the case of printing a confidential document or the like, the MFP first confirms that a user corresponding to the confidential document is around the MFP, and then starts printing the confidential document or unlocks a locked mailbox bin containing the confidential document therein. This prevents a printed material from being left unremoved from a locked mailbox bin, or from being carried away by somebody else, which enhances the security of the printed material.

According to the method in which printing is started in response to the entry of a password, no problem arises when a print quantity of a document to be printed is small. The method, however, causes a problem for a user when the print quantity is large because the user has to wait for a quite while for the printing to be completed around the MFP.

To cope with this, a technique is disclosed in Japanese Laid-open Patent Publication No. 2004-306287. The technique involves outputting, when a print quantity of a document to be printed is greater than a predetermined value, the printed material to a locked mailbox bin, and outputting, when the print quantity is equal to or less than the predetermined value, the printed material to a regular mailbox bin. The technique is hereinafter referred to as the “first technique”.

According to the first technique, if a document takes a long time to print, an MFP outputs the printed material to a locked mailbox bin. The first technique, thus, avoids an undesirable situation in which somebody else carries away the printed material even if a user leaves the MFP.

Another technique is also known in which, before a user reaches an MFP, printing is started and a printed material is outputted to a locked mailbox bin in advance (Japanese Laid-open Patent Publication No. 2006-001241). The technique is hereinafter referred to as the “second technique”. Since the number of locked mailbox bins is limited, a case may arise in which printing is not completed when all the locked mailbox bins are occupied. To cope with this, the second technique involves, when all the locked mailbox bins are occupied, putting a print job into standby, prompting a user to undergo authentication by the MFP based on a card or the like, and then starting printing a document to output the printed material to a covered mailbox bin rather than a locked mailbox bin.

According to the second technique, even if all the locked mailbox bins are occupied, the MFP starts printing immediately after confirming that the user is around the MFP. The second technique, thus, avoids an undesirable situation in which somebody else carries away the printed material even if the user leaves the MFP.

The first and second techniques ensure the confidentiality of a printed material. In the case, however, where a print quantity is large, a user still has to wait for a while for the printing to be completed.

In the first technique, for example, a print job received by the MFP is temporarily stored therein. In order to perform printing based on the print job, a user has to go to a place where the MFP is installed and operate the MFP to undergo authentication. The user may leave the MFP when a print quantity is large, because the printed material is to be outputted to a locked mailbox bin. However, the first technique does not reduce the time for the user to wait for the completion of printing based on a print job for a large print quantity. Further, according to the second technique, if a job is a confidential job, the MFP is capable of starting printing and outputting the printed material to a locked mailbox bin before a user reaches a place where the MFP is installed. However, as long as the MFP receives confidential jobs, even if a print quantity for one print job is very small, the MFP attempts to output the printed materials to locked mailbox bins until all the locked mailbox bins are occupied. This causes a problem that printing based on a print job for a large print quantity, which inherently takes a long time to print, cannot be performed while there is no availability of locked mailbox bins. Unless the problem of non-availability of locked mailbox bins is solved, a user is highly likely to wait, around the MFP, for the completion of printing based on a print job for a large print quantity even if a covered mailbox bin is used for the printing.

### SUMMARY

The present disclosure is directed to solve the problems pointed out above, and therefore, an object of an embodiment of the present invention is to provide an image forming apparatus that reduces, in the case of secure printing, the time for a user to wait for the completion of printing by using locked mailbox bins effectively.

According to an aspect of the present invention, an image forming apparatus includes a locked mailbox bin. The image forming apparatus includes a job receiving portion that receives a print job, a print quantity calculation portion that calculates a print quantity for a case in which the print job thus received is executed, a storage portion that stores, therein, the print job based on which printing is executed in response to operation for authenticating a user, and a controller that performs control such that, if the print quantity for the print job calculated by the print quantity calculation portion is more than a predetermined quantity, printing based on the print job is executed with the locked mailbox bin designated as an output destination of a printed material, and, if the print quantity for the print job calculated by the print quantity calculation portion is equal to or less than the predetermined quantity, the storage portion stores the print job therein.

Thus, in the case where a quantity of a printed material based on a received print job is greater than a predetermined quantity, there is a high likelihood that the image forming apparatus configured as described above starts printing in advance and outputs the printed material to a locked mailbox bin before a user reaches the image forming apparatus.

These and other characteristics and objects of the present invention will become more apparent by the following descriptions of preferred embodiments with reference to drawings.

### BRIEF DESCRIPTION OF THE DRAWINGS

FIG. 1 is a diagram illustrating an example of the overall configuration of a secure printing system using an MFP.

FIG. 2 is an example of a schematic external view of an MFP.

FIG. 3 is a diagram illustrating an example of the hardware configuration of an MFP.

FIG. 4 is a block diagram illustrating an example of the functional configuration of a user terminal and an MFP.

FIG. 5A is a diagram illustrating an example of the configuration and details of user information, and FIG. 5B is a diagram illustrating an example of the configuration and details of user level information.

FIG. 6 is a diagram illustrating an example of the configuration and details of print level information.

FIG. 7 is a diagram illustrating an example of the configuration and details of a secure job management table.

FIG. 8 is a diagram illustrating an example of a log-on screen.

FIG. 9 is a diagram illustrating an example of a print job list screen.

FIG. 10 is a diagram illustrating an example of a message window.

FIG. 11 is a diagram illustrating an example of a message window.

FIG. 12 is a diagram illustrating an example of a print job.

FIG. 13 is a flowchart illustrating an example of optimum print processing.

FIG. 14 is a flowchart illustrating an example of printed material acquisition processing.

FIG. 15 is a diagram illustrating an example of the configuration and details of print level information according to a second embodiment.

FIG. 16 is a flowchart illustrating an example of optimum print processing according to a second embodiment.

FIG. 17A is a diagram illustrating a modified example of the configuration and details of user level information, and FIG. 17B is a diagram illustrating a further modified example of the configuration and details of user level information.

### DESCRIPTION OF THE PREFERRED EMBODIMENTS

### First Embodiment

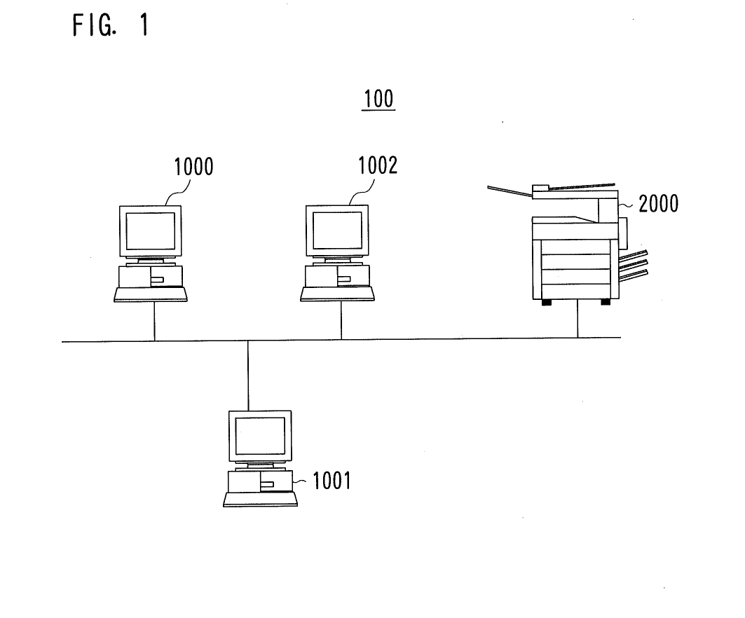

An MFP (MFP 2000 of FIG. 1) that is an image forming apparatus according to this embodiment is provided with a locked (lockable) mailbox bin and a regular (unlocked, i.e., unlockable, open) mailbox bin. The MFP receives print jobs from terminals of users (terminals 1000-1002 of FIG. 1, each of which is hereinafter referred to as a “user terminal”) and performs printing.

A print job according to this embodiment comes in two types, i.e., a “regular print job” and a “secure print job”.

The regular print job is a job to instruct the MFP to perform printing by using a method in which the confidentiality of a printed material is not maintained. When receiving regular print jobs, the MFP performs printing in the order that the regular print jobs have been received, and outputs, to the regular mailbox bin, printed materials based on the regular print jobs.

The secure print job is a job to instruct the MFP to perform printing by using a method in which the confidentiality of a printed material is maintained. It is assumed that, in this embodiment, the secure printing comes in two types, i.e., a password-protected printing and a locked mailbox bin printing. In the former type, printing is not started until a password is entered. In the latter type, printing is performed in advance and a printed material is outputted to a locked mailbox bin. Hereinafter, a secure print job for password-protected printing is referred to as a “password-protected print job”, and a secure print job for locked mailbox bin printing is referred to as a “locked mailbox bin print job”.

Upon receiving a secure print job, the MFP according to this embodiment determines whether printing is to be performed as a password-protected print job or a locked mailbox bin print job with reference to the details of the secure print job received, and the number of available locked mailbox bins.

Stated differently, the MFP makes such a determination in order to minimize the waiting time from when a user enters a password into the MFP until he/she obtains a printed material.

In this embodiment, the details of the secure print job, which are referred to when the MFP makes the determination, are a print quantity for the case where printing is performed based on the secure print job, and a title (managerial title) of a user who has transmitted the secure print job. The title is one of attributes of the user.

Specifically, if a print quantity based on the secure print job is more than a predetermined number of prints, then the MFP basically determines that the secure print job is regarded as a locked mailbox bin print job. This reduces the waiting time of the user to be equal to or shorter than the length of time necessary for printing for the predetermined number of prints to be completed. In other words, in the case of a secure print job for which a print quantity is more than the predetermined number of prints, printing is performed in advance and the printed material is outputted to a locked mailbox bin, which minimizes the waiting time of the user. In the case of a secure print job for which a print quantity is equal to or less than the predetermined number of prints, the waiting time of the user is reduced to be equal to or shorter than the length of time necessary for printing for the predetermined number of prints to be completed.

However, if a print quantity based on the secure print job is more than a predetermined number of prints, and if the number of available locked mailbox bins is less than a predetermined value, then the MFP determines that the secure print job is regarded as a password-protected print job. This is because available locked mailbox bins are to be saved for incoming secure print jobs that should be regarded as locked mailbox bin print jobs.

A secure print job transmitted from a user terminal is subjected to the process described above. Thereby, it is possible to minimize the waiting time, and assign a locked mailbox bin to a secure print job for which a locked mailbox bin is required compared to other secure print jobs, that is, to use a locked mailbox bin effectively. The MFP according to this embodiment can reduce, in the case of secure printing, the time for a user to wait for the completion of printing by using locked mailbox bins effectively.

In this embodiment, a print quantity and the number of available locked mailbox bins, both of which are used to make a determination as to whether a secure print job is regarded as a password-protected print job or a locked mailbox bin print job, are different depending on titles of users that are attributes thereof. This embodiment thereby enables the MFP to perform a process corresponding to a print job suitable for a user.

Descriptions are given below of a secure printing system using the MFP according to an embodiment of the present invention, with reference to drawings.

FIG. 1 is a diagram illustrating an example of the overall configuration of a secure printing system 100 using the MFP 2000 according to this embodiment.

The secure printing system 100 is configured of user terminals 1000, 1001, and 1002, the MFP 2000, and so on, all of which are connected in a network.

The MFP 2000 is generally called a multifunction device, and is configured to integrate, thereinto, a variety of functions, such as copying, faxing, network printing, scanning, and a box function.

The user terminal 1000 is a terminal for a user to transmit a print job.

Each of the user terminals 1001 and 1002 has the same function as that of the user terminal 1000. Only the user terminal 1000 is described herein as a representative example.

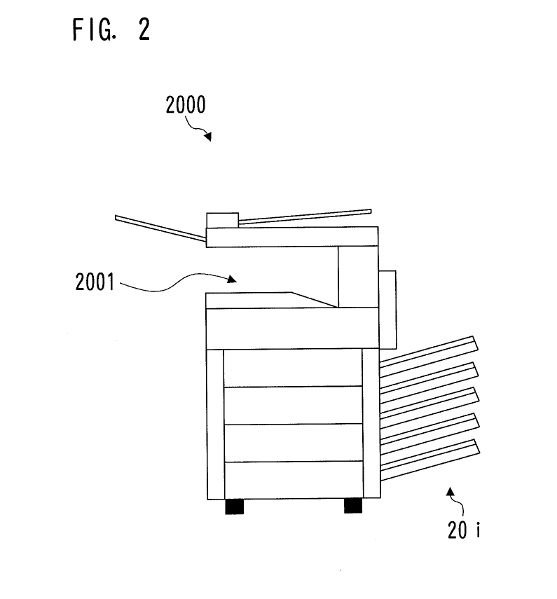

FIG. 2 is an example of a schematic external view of the MFP 2000.

The MFP 2000 is provided with a regular (unlocked, i.e., unlockable, open) mailbox bin 2001 and a plurality of locked mailbox bins 20i. Hereinafter, the plurality of locked mailbox bins 20i may be collectively referred to as a “locked mailbox bin 20i” for purposes of simplicity.

The locked mailbox bin 20i has a box shape with cover. The locked mailbox bin 20i is to temporarily keep, therein, printed and ejected paper. Since the cover of the locked mailbox bin 20i is locked with an electronic lock under a normal state, a printed material kept in the locked mailbox bin 20i is not removed therefrom. The MFP 2000 unlocks the electronic lock; thereby the cover of the locked mailbox bin 20i can be opened, so that the printed material contained therein is removed therefrom.

Descriptions are provided below of the hardware configuration of the MFP 2000.

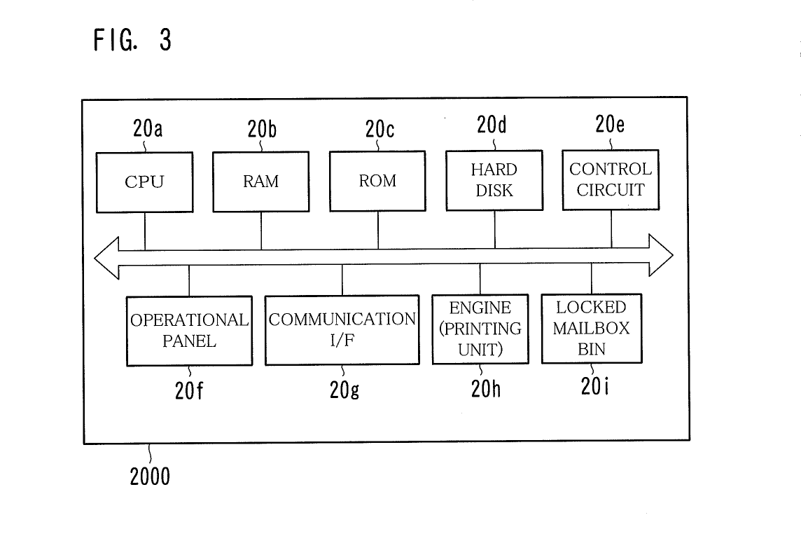

FIG. 3 is a diagram illustrating an example of the hardware configuration of the MFP 2000.

The MFP 2000 is configured of a Central Processing Unit (CPU) 20a, a Random Access Memory (RAM) 20b, a Read-Only Memory (ROM) 20c, a hard disk 20d, a control circuit 20e, an operational panel 20f, a communication interface 20g, a printing unit 20h, the locked mailbox bin 20i, and so on.

The control circuit 20e is a circuit for controlling the hard disk 20d, the operational panel 20f, the communication interface 20g, the printing unit 20h, the locked mailbox bin 20i, and so on.

The operational panel 20f is a touch-screen display panel that displays, for example, a screen for giving a message or instructions to a user, a screen for the user to enter, for example, a desired process type and desired process conditions, and a screen for displaying the result of a process performed by the CPU 20a. The user can give instructions, specify process conditions, or enter a password to the MFP 2000 by touching a predetermined position of the operational panel 20f. Thus, the operational panel 20f acts as a user interface for the user who operates the MFP 2000.

The communication interface 20g is a Network Interface Card (NIC) for communicating with another device such as the user terminal 1001 according to Transmission Control Protocol/Internet Protocol (TCP/IP) via a communication line, or a modem.

The printing unit 20h serves to print, onto paper, an image reproduced based on image data of a print job transmitted by the user terminal 1000, and the like.

The locked mailbox bin 20i is a mailbox bin with electronic key, and, as described earlier, is configured of a plurality of locked mailbox bins (see FIG. 2). It is assumed that, in this embodiment, the locked mailbox bin 20i is configured of five locked mailbox bins.

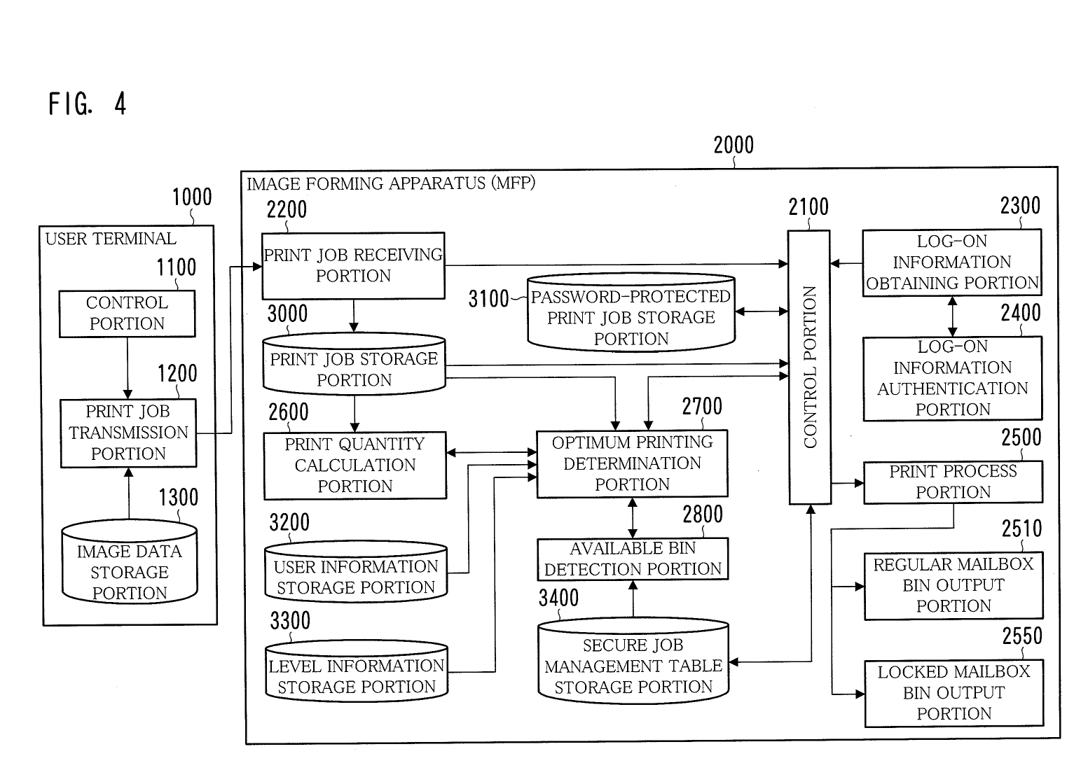

Descriptions are provided below, with reference to FIG. 4, of the user terminal 1000 and the MFP 2000, both of which constitute the secure printing system 100.

FIG. 4 is a block diagram illustrating an example of the functional configuration of the user terminal 1000 and the MFP 2000.

The user terminal 1000 is a so-called personal computer, and is provided with interfaces such as a display and a keyboard.

The user terminal 1000 includes a control portion 1100, a print job transmission portion 1200, and an image data storage portion 1300.

A CPU executes programs stored in a memory of the user terminal 1000; thereby the functions of the individual portions of the user terminal 1000 are implemented as described below.

The control portion 1100 performs general control processing necessary for the user terminal 1000, and control processing unique to the present invention.

The print job transmission portion 1200 serves to generate a print job and to transmit the print job to the MFP 2000 in accordance with a command given by the control portion 1100. In short, the print job transmission portion 1200 is a so-called printer driver.

As described earlier, the print job comes in two types, i.e., a regular print job and a secure print job. When transmitting a print job to the MFP 2000, a user specifies the type of the print job.

The image data storage portion 1300 serves to store image data therein. The image data herein is data of a document, illustration, or the like to be printed in the form of Joint Photographic Experts Group (JPEG), Graphics Interchange Format (GIF), or the like.

The MFP 2000 is configured of a control portion 2100, a print job receiving portion 2200, a log-on information obtaining portion 2300, a log-on information authentication portion 2400, a print process portion 2500, a regular mailbox bin output portion 2510, a locked mailbox bin output portion 2550, a print quantity calculation portion 2600, an optimum printing determination portion 2700, an available bin detection portion 2800, a print job storage portion 3000, a password-protected print job storage portion 3100, a user information storage portion 3200, a level information storage portion 3300, a secure job management table storage portion 3400, and the like.

The CPU 20a executes programs stored in the memory such as the hard disk 20d of the MFP 2000; thereby the functions of the individual portions of the MFP 2000 are implemented as described below.

The control portion 2100 performs general control processing necessary for the MFP 2000, and control processing unique to the present invention.

The print job receiving portion 2200 serves to receive a print job from the user terminal 1000. The print job receiving portion 2200 stores the print job thus received in the print job storage portion 3000, and informs the control portion 2100 that the print job has been received.

The log-on information obtaining portion 2300 serves to obtain log-on information such as a user name and a password from a user who intends to use the MFP 2000. To be specific, a screen for the user to enter the log-on information is displayed on the operational panel 20f and the user name and the like entered by the user are obtained.

The log-on information obtaining portion 2300 also causes the log-on information authentication portion 2400 to perform authentication of the log-on information obtained. Only when the log-on information is verified, the log-on information obtaining portion 2300 informs the control portion 2100 of the log-on information.

The log-on information authentication portion 2400 serves to perform authentication of log-on information. Specifically, the log-on information authentication portion 2400 refers to a plurality of pieces of user information stored in the user information storage portion 3200. If the log-on information is indicated in any one of the plurality of pieces of the user information, then it means that the authentication is successful. If the log-on information is not indicated in the plurality of pieces of the user information, then it means that the authentication fails.

The print process portion 2500 receives a print job from the control portion 2100, and executes the print job. To be specific, the print process portion 2500 prints, onto paper, an image reproduced based on image data included in the print job. The print process portion 2500 gives a command to the regular mailbox bin output portion 2510 or the locked mailbox bin output portion 2550 in order to control the output destination of the printed material. The control portion 2100 gives the print process portion 2500 instructions, together with a request for printing, as to whether the print process portion 2500 should give the command to the regular mailbox bin output portion 2510 or the locked mailbox bin output portion 2550. The control portion 2100 also informs the print process portion 2500 of the sequential number of the locked mailbox bin to which the printed material is to be directed for a case where the print process portion 2500 should give the command to the locked mailbox bin output portion 2550.

The regular mailbox bin output portion 2510 serves to output the printed material processed by the print process portion 2500 to the regular mailbox bin 2001 (see FIG. 2).

The locked mailbox bin output portion 2550 serves to output the printed material processed by the print process portion 2500 to, among the locked mailbox bin 20i (see FIG. 2), the locked mailbox bin to which the sequential number informed by the control portion 2100 is assigned.

Upon receiving a request from the optimum printing determination portion 2700, the print quantity calculation portion 2600 serves to calculate a print quantity for a case in which printing is performed based on a print job. For example, if 100 copies of a document containing three pages are to be printed, the print quantity is 300.

The optimum printing determination portion 2700 serves to determine an optimum printing method based on a secure print job in response to a request from the control portion 2100. To be specific, the optimum printing determination portion 2700 determines whether the secure print job is to be treated as a password-protected print job or a locked mailbox bin print job. At this time, the optimum printing determination portion 2700 makes the determination with reference to information on users stored in the user information storage portion 3200 and information on print levels stored in the level information storage portion 3300.

The available bin detection portion 2800 serves to obtain the number of available bins of the locked mailbox bins in response to a request from the optimum printing determination portion 2700. Specifically, the available bin detection portion 2800 refers to a table for managing secure print jobs stored in the secure job management table storage portion 3400, and then obtains the number of available locked mailbox bins.

The print job storage portion 3000 serves to store, therein, print jobs received from the user terminal 1000. A regular print job and a locked mailbox bin print job among the print jobs stored in the print job storage portion 3000 are sent to the print process portion 2500 via the control portion 2100.

The password-protected print job storage portion 3100 serves to store, therein, password-protected print jobs of secure print jobs. A password-protected print job stored in the password-protected print job storage portion 3100 is sent to the print process portion 2500 via the control portion 2100.

In this embodiment, it is assumed that only a password-protected print job is stored in the password-protected print job storage portion 3100 for the convenience of description. Instead, however, the password-protected print job may be stored in the print job storage portion 3000.

The user information storage portion 3200 stores, therein, a plurality of pieces of user information that is information on users.

The level information storage portion 3300 stores, therein, on a level-by-level basis, a plurality of pieces of information based on which a determination is made as to whether a secure print job is to be treated as a locked mailbox bin print job or a password-protected print job.

The secure job management table storage portion 3400 stores, therein, a management table for managing secure print jobs. The management table is appropriately updated, for example, when the MFP 2000 receives a secure print job.

Note that data stored in the user information storage portion 3200, data stored in the level information storage portion 3300, and data stored in the secure job management table storage portion 3400 will be described below in the [DATA] section with reference to drawings.

[DATA]

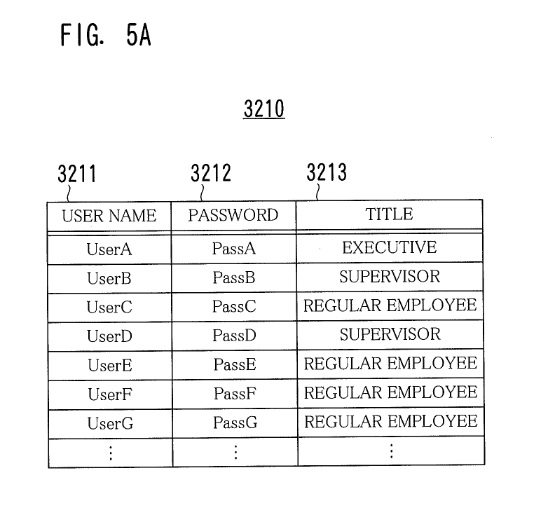

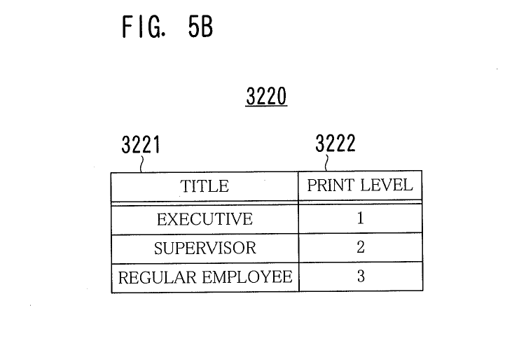

The following is a description of data used in the secure printing system 100 of this embodiment, with reference to FIGS. 5A-7.

FIG. 5A is a diagram illustrating an example of the configuration and details of user information 3210, and FIG. 5B is a diagram illustrating an example of the configuration and details of user level information 3220.

The user information 3210 and the user level information 3220 are created in advance by an MFP administrator, and stored in the user information storage portion 3200.

The user information 3210 is described below with reference to FIG. 5A.

The user information 3210 includes the fields of “user name” 3211, “password” 3212, and “title” 3213. The user information 3210 contains information about all the users who are permitted to use the MFP 2000. One record having the fields described above is registered for one user.

The user name field 3211 indicates a name of a user.

The password field 3212 indicates information based on which a determination is made as to whether or not a user indicated in the user name field 3211 is authorized to use the MFP 2000.

The title field 3213 indicates a title of a user indicated in the user name field 3211.

The user level information 3220 is described below with reference to FIG. 5B.

The user level information 3220 includes the fields of “title” 3221 and “print level” 3222.

The title field 3221 indicates a title of a user which is one of attributes of the user.

The print level field 3222 indicates a print level of a user corresponding to an attribute specified in the title field 3221. The print level herein means a priority that a print job transmitted by the user is to be treated as a locked mailbox bin print job. In other words, the print level is an index of the length of the time during which the user has to wait around the MFP 2000 in order to obtain a printed material.

The print level “1” has the highest priority among print levels. The print level “1” means that a transmitted print job is most likely to be treated as a locked mailbox bin print job, and the waiting time is most likely to be short.

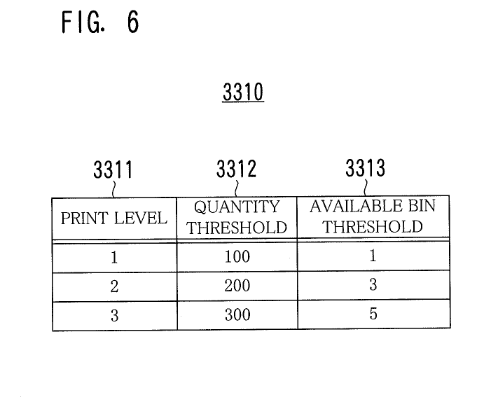

FIG. 6 is a diagram illustrating an example of the configuration and details of print level information 3310.

The print level information 3310 is created in advance by an MFP administrator, and stored in the level information storage portion 3300. The print level information 3310 defines specific information on levels indicated in the print level field 3222 of the user level information 3220.

The print level information 3310 includes the fields of “print level” 3311, “quantity threshold” 3312, and “available bin threshold” 3313.

The print level field 3311 indicates a priority that a print job is to be treated as a locked mailbox bin print job. The value “1” in the print level field 3311 means the highest priority among print levels.

The quantity threshold field 3312 indicates a threshold of a quantity of a printed material.

The available bin threshold field 3313 indicates a threshold of the number of available bins which is the number of available locked mailbox bins.

The values in the quantity threshold field 3312 and the available bin threshold field 3313 are used for a determination as to whether a print job is regarded as a locked mailbox bin print job or a password-protected print job.

For example, a print job transmitted by a user corresponding to the value “1” in the print level field 3311 is determined to be a locked mailbox bin print job, if a print quantity based on the print job is more than the value “100” in the quantity threshold field 3312, and the number of available locked mailbox bins at the time of the receipt of the print job is more than the value “1” in the available bin threshold field 3313.

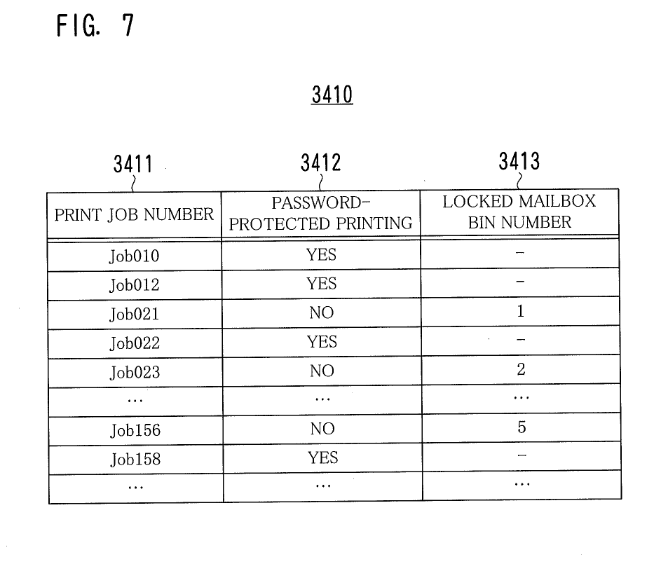

FIG. 7 is a diagram illustrating an example of the configuration and details of a secure job management table 3410. The secure job management table 3410 is stored in the secure job management table storage portion 3400.

The secure job management table 3410 includes the fields of “print job number” 3411, “password-protected printing” 3412, and “locked mailbox bin number” 3413.

Every time when the MFP 2000 receives one print job from the user terminal 1000, one record having the fields described above is registered in the secure job management table 3410. When a user obtains a printed material, a record of a print job corresponding to the printed material is deleted from the secure job management table 3410.

Stated differently, the secure job management table 3410 manages, among secure print jobs received from users, a password-protected print job for which printing has not yet been performed and a locked mailbox bin print job for which the printed material has not yet been picked up by a user.

The print job number field 3411 indicates a print job number that is an identifier of a secure print job. It is assumed that, in this embodiment, the print job receiving portion 2200 gives any numbers to secure print jobs in order to manage the secure print jobs.

The password-protected printing field 3412 indicates whether or not a secure print job to which a print job number specified in the print job number field 3411 is assigned is a password-protected print job. If “YES” is indicated in the password-protected printing field 3412, then the secure print job is a password-protected print job. If “NO” is indicated therein, then the secure print job is a locked mailbox bin print job.

Referring to FIG. 7, for example, a secure print job having “Job010” in the print job number field 3411 is a password-protected print job because “YES” is indicated in the password-protected printing field 3412 of the secure print job. Thus, the secure print job is stored in the password-protected print job storage portion 3100.

The locked mailbox bin number field 3413 indicates the sequential number of a locked mailbox bin to which a printed material corresponding to a secure print job having a print job number indicated in the print job number field 3411 is outputted. Values in the locked mailbox bin number field 3413 are effective only when “NO” is indicated in the password-protected printing field 3412 of the corresponding records.

For example, referring to a secure print job having “Job021” in the print job number field 3411, printing has been performed based on the secure print job, and the printed material is outputted to a locked mailbox bin to which the sequential number “1” is assigned and kept therein. This is because “NO” and “1” are respectively indicated in the password-protected printing field 3412 and the locked mailbox bin number field 3413 of the secure print job.

[Indication on Display]

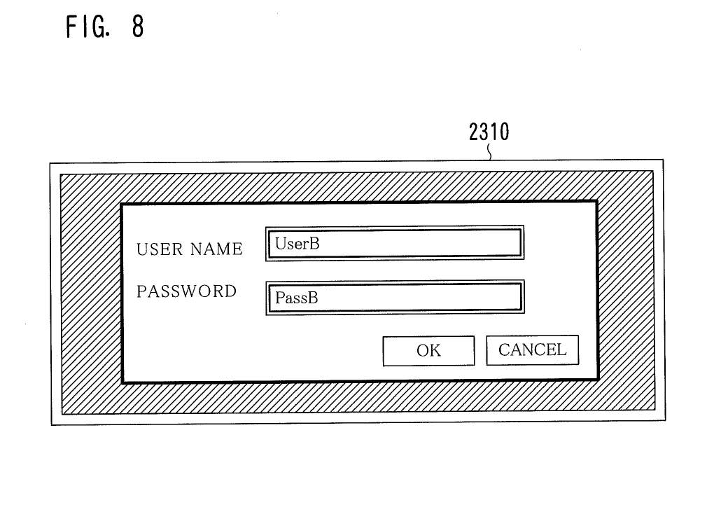

Descriptions are given below of main indications on a display used in the secure printing system 100 of this embodiment, with reference to FIGS. 8-11. The indications on a display described herein are examples of indications made on the operational panel 20f of the MFP 2000.

FIG. 8 is a diagram illustrating an example of a log-on screen 2310.

A user enters, on the log-on screen 2310, a user name and a password in the individual entry fields, and then presses an “OK” button.

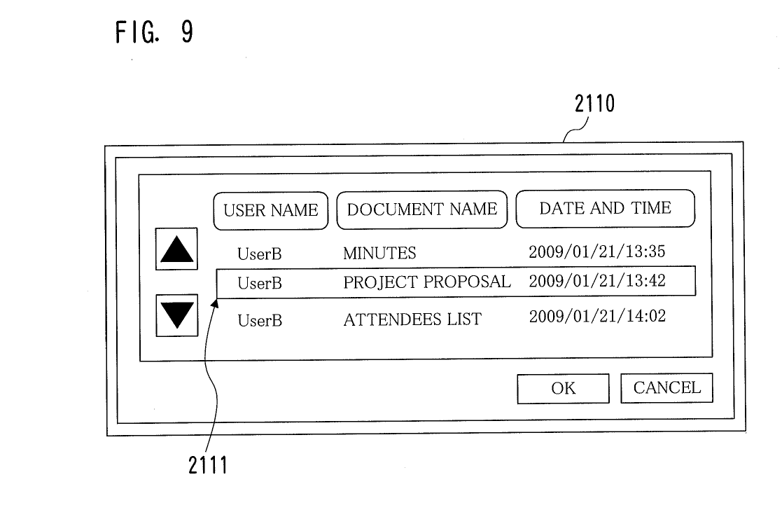

FIG. 9 is a diagram illustrating an example of a print job list screen 2110.

The print job list screen 2110 is to display a list of secure print jobs transmitted by a user who has logged onto the MFP 2000. The user moves a cursor 2111 to select a desired print job. In the illustrated example, a print job having a document name of “project proposal” is selected by moving the cursor 2111. If the user presses an “OK” button, then a process such as printing corresponding to the selected print job is performed.

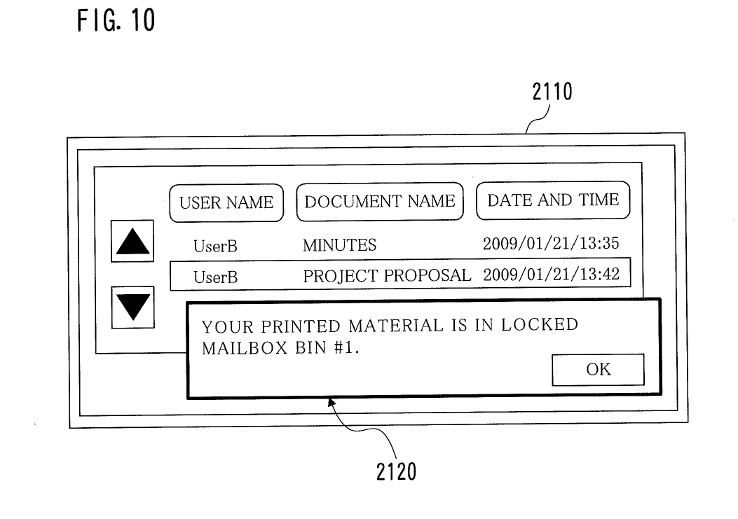

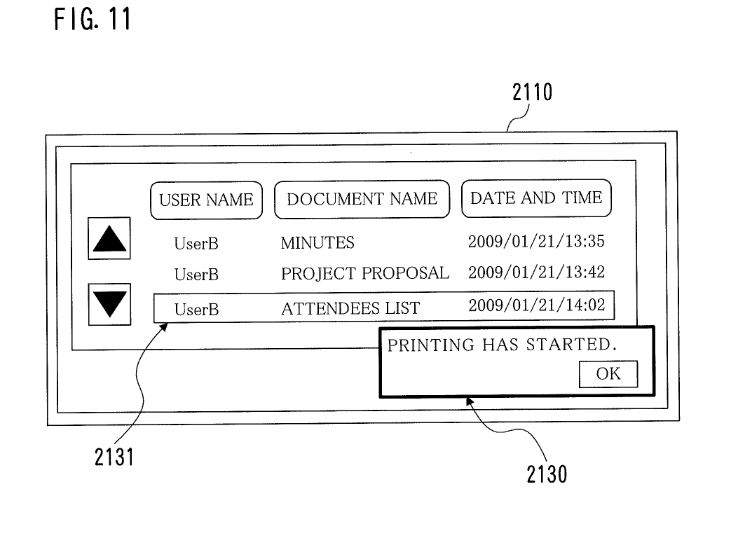

FIGS. 10 and 11 are diagrams illustrating message windows 2120 and 2130 respectively that are displayed when a print job is selected and the “OK” button is pressed on the print job list screen 2110. Each of the message windows 2120 and 2130 is displayed to overlap the print job list screen 2110.

FIG. 10 is a diagram illustrating the message window 2120 for a case in which a print job selected on the print job list screen 2110 is a locked mailbox bin print job. The message window 2120 shows the sequential number of a locked mailbox bin to which a printed material is already outputted. If the user presses an “OK” button in the message window 2120, then the print job list screen 2110 is displayed once again (see FIG. 9).

FIG. 11 is a diagram illustrating the message window 2130 for a case in which a print job selected on the print job list screen 2110 is a password-protected print job. The message window 2130 shows a message indicating that printing has been started.

FIG. 11 illustrates indication in which the message window 2130 appears after a print job corresponding to a document name of “list of attendees” has been selected by moving the cursor 2131 and the “OK” button has been pressed.

If the user presses an “OK” button in the message window 2130, then the print job list screen 2110 is displayed once again (see FIG. 9).

In this embodiment, it is unnecessary for a user to enter a password or the like every time when a print job is executed because the password is already verified when the user has logged onto the MFP 2000.

[Print Job]

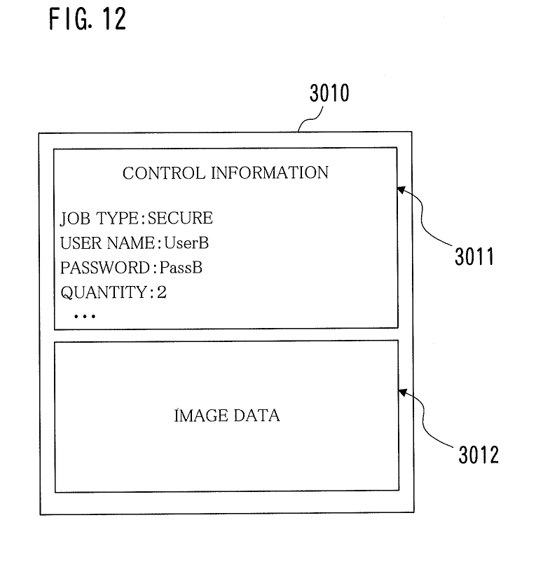

Descriptions are given below of a print job used in the secure printing system 100 of this embodiment, with reference to FIG. 12.

FIG. 12 is a diagram illustrating an example of a print job 3010.

The print job 3010 includes control information 3011 and image data 3012.

The control information 3011 contains information about the type of a job, a user name, a password, a quantity, and the like.

The type of a job indicates whether the corresponding print job is a regular print job or a secure print job. The type of the print job is determined when a user generates a print job.

The user name is a name of a user of the user terminal 1000. The password is information for authenticating the user. The quantity indicates the number of prints based on the image data 3012.

The image data 3012 is data of, for example, a document to be printed, and is provided in a predetermined format such as PDF, TIFF, or JPEG. Images such as characters, drawings, or symbols are printed onto paper based on the image data 3012.

[Operation]

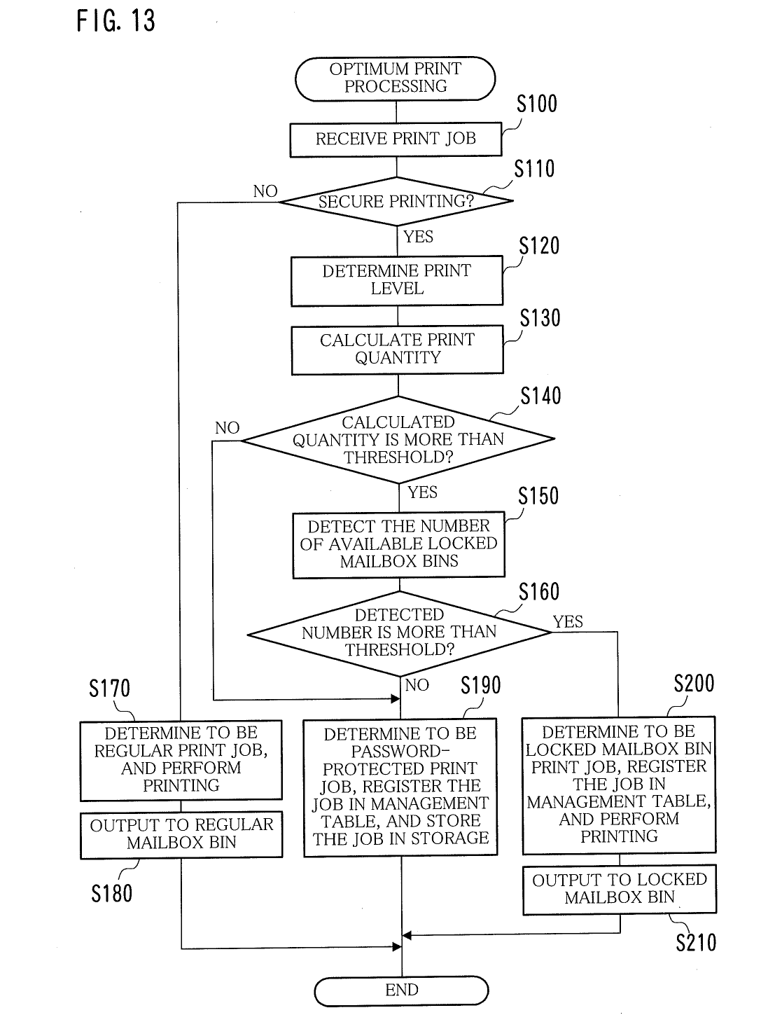

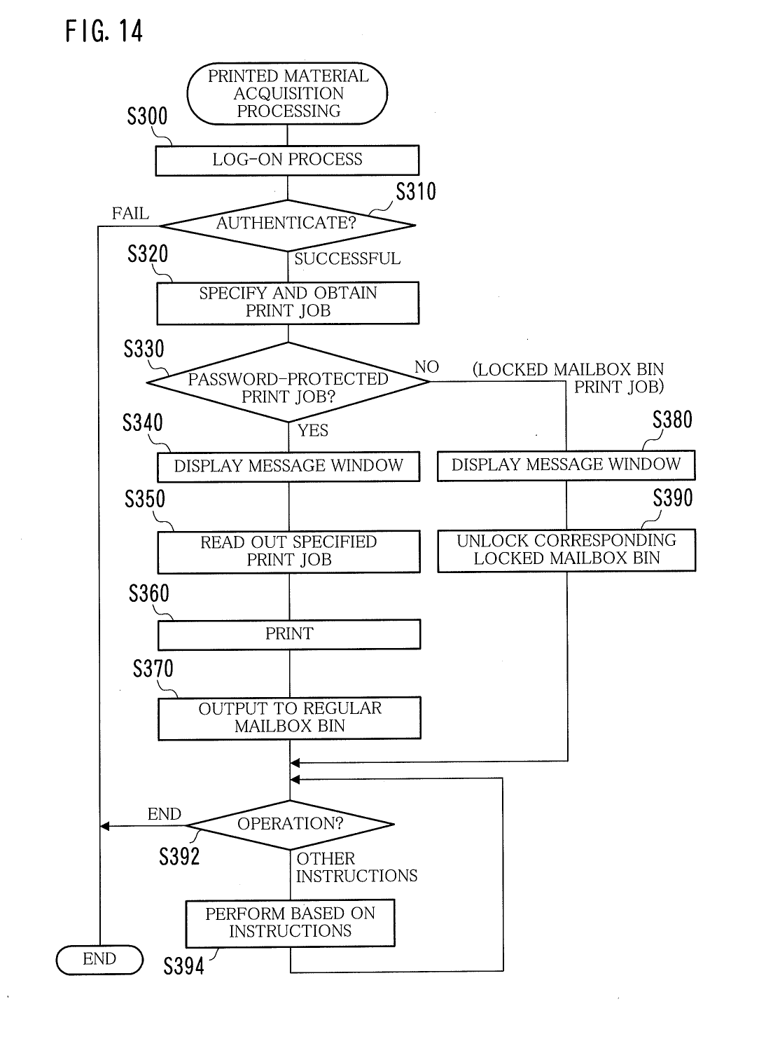

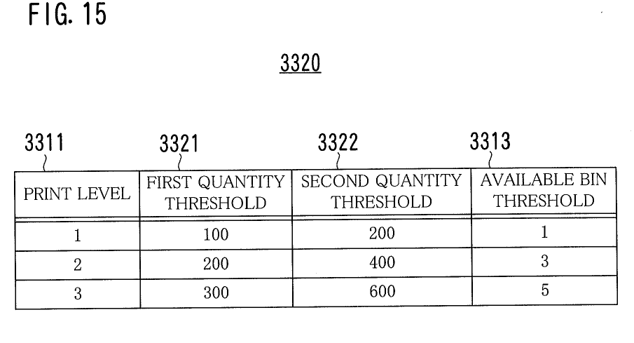

The following is a description of operation performed in the secure printing system 100 of this embodiment, with reference to FIGS. 13 and 14.

FIG. 13 is a flowchart illustrating an example of optimum print processing performed by the MFP 2000.

A user operates the user terminal 1000 to designate control information and image data of a print job, and gives a print command. The user designates, as the control information, the type of the print job, i.e., a regular print job or a secure print job, the number of prints, and the like.

The control portion 1100 of the user terminal 1000 obtains the print command given by the user, the designation of image data, and the like. The control portion 1100 then requests the print job transmission portion 1200 to transmit a print job for printing the designated image data to the MFP 2000.

Responding to this, the print job transmission portion 1200 reads out a user name and a password stored in an internal memory thereof, also reads out the designated image data from the image data storage portion 1300. The print job transmission portion 1200 then generates a print job 3010 (see FIG. 12), and transmits the print job 3010 to the MFP 2000.

The print job receiving portion 2200 of the MFP 2000 receives the print job 3010 transmitted by the user terminal 1000 (Step S100).

The print job receiving portion 2200 assigns a job number to the print job 3010 thus received, and stores, into the print job storage portion 3000, the received print job 3010 in association with the assigned job number.

The print job receiving portion 2200 further informs the control portion 2100 of a message indicating that the print job has been received, and of the assigned job number.

Responding to this, the control portion 2100 determines whether the print job corresponding to the job number thus informed is a regular print job or a secure print job (Step S110).

To be specific, the control portion 2100 refers to the control information 3011 of the print job 3010 stored in the print job storage portion 3000. If “secure” is specified as the type of a job, then the control portion 2100 determines that the print job corresponding to the informed job number is a secure print job. Otherwise, the control portion 2100 determines that the print job corresponding to the informed job number is a regular print job.

If determining that the print job is a regular print job (Step S110: No), then the control portion 2100 reads out the print job corresponding to the informed job number from the print job storage portion 3000, and requests the print process portion 2500 to perform printing based on the print job thus read out. At this time, the control portion 2100 also requests the print process portion 2500 to direct a printed material based on the print job to a regular mailbox bin.

Upon receiving the request, the print process portion 2500 performs printing onto paper based on the image data 3012 of the print job 3010, and gives a command to the regular mailbox bin output portion 2510 (Step S170).

Responding to this, the regular mailbox bin output portion 2510 outputs the printed material to the regular mailbox bin 2001 (see FIG. 2) (Step S180).

On the other hand, if determining that the print job is a secure print job (Step S110: Yes), then the control portion 2100 requests the optimum printing determination portion 2700 to determine whether the secure print job is to be treated as a password-protected print job or a locked mailbox bin print job. At this time, the control portion 2100 sends, to the optimum printing determination portion 2700, the job number received from the print job receiving portion 2200.

Upon receiving the request, the optimum printing determination portion 2700 refers to a print job 3010 stored in the print job storage portion 3000, and reads out a user name and a password from the print job 3010. Note that the print job 3010 to be referred to is a print job corresponding to the job number received from the control portion 2100.

The optimum printing determination portion 2700 subsequently refers to the user information 3210 and the user level information 3220 stored in the user information storage portion 3200, and determines a print level (Step S120). It is assumed that the print level thus determined is stored in a work memory.

The determination of the print level is performed in the following manner.

The optimum printing determination portion 2700 searches for the user name and the password that have been read out from the print job 3010 in the user name field 3211 and the password field 3212 of the user information 3210.

If the user name and the password are found by the search, then the optimum printing determination portion 2700 reads out a title indicated in the title field 3213 of a record corresponding to the found user name. The optimum printing determination portion 2700 then checks whether or not the title indicated in the title field 3213 thus read out is registered in the title field 3221 of the user level information 3220.

If registered, then the optimum printing determination portion 2700 determines that a print level specified in the print level field 3222 corresponding to the registered title is the print level of the print job 3010.

Suppose that, for example, the user name and the password contained in the print job 3010 are “UserB” and “PassB”, respectively. Referring to FIG. 5A, “supervisor” is specified in the title field 3213 for a record having “UserB” and “PassB” in the user name field 3211 and the password field 3212 of the user information 3210, respectively. Referring then to the user level information 3220 of FIG. 5B, the print level field 3222 of a record having “supervisor” in the title field 3221 specifies the value “2”. Thus, the print level of the print job 3010 is determined to be “2”.

After that, the optimum printing determination portion 2700 requests the print quantity calculation portion 2600 to calculate a print quantity based on the print job 3010. At this time, the optimum printing determination portion 2700 sends the job number to the print quantity calculation portion 2600.

Responding to this, the print quantity calculation portion 2600 refers to a print job 3010 stored in the print job storage portion 3000, and calculates a print quantity for a case in which printing is performed based on the print job 3010 (Step S130). Note that the print job 3010 to be referred to is a print job corresponding to the job number received from the optimum printing determination portion 2700.

To be specific, the print quantity calculation portion 2600 determines, as the print quantity, a value obtained by multiplying the number of prints by the number of pages of a document specified in the control information 3011 of the print job 3010.

The print quantity calculation portion 2600 then sends the print quantity thus determined to the optimum printing determination portion 2700.

Upon receiving the print quantity, the optimum printing determination portion 2700 obtains the quantity threshold and the number of available locked mailbox bins corresponding to the print level that has been determined in Step S120 and stored in the work memory. At this time, the optimum printing determination portion 2700 refers to the print level information 3310 stored in the level information storage portion 3300.

Specifically, the optimum printing determination portion 2700 refers to a record having the same print level as that stored in the work memory, and obtains the values in the quantity threshold field 3312 and the available bin threshold field 3313 of the record as the quantity threshold and the available bin threshold corresponding to the print level.

The optimum printing determination portion 2700 then compares the print quantity received from the print quantity calculation portion 2600 with the quantity threshold of the print level (Step S140).

If the print quantity received from the print quantity calculation portion 2600 is equal to or less than the quantity threshold of the print level (Step S140: No), then the optimum printing determination portion 2700 determines that the print job 3010 is to be treated as a password-protected print job, and informs the control portion 2100 of the fact.

In contrast, if the print quantity received from the print quantity calculation portion 2600 is more than the quantity threshold of the print level (Step S140: Yes), then the optimum printing determination portion 2700 requests the available bin detection portion 2800 to obtain the number of available locked mailbox bins.

Responding to this, the available bin detection portion 2800 refers to the secure job management table 3410 stored in the secure job management table storage portion 3400, and obtains the number of available locked mailbox bins (Step S150).

To be specific, the available bin detection portion 2800 searches in the locked mailbox bin number field 3413 of the secure job management table 3410, and obtains the number of records each of which has a value in the locked mailbox bin number fields 3413. The available bin detection portion 2800 then subtracts the obtained number from the total number of locked mailbox bins provided in the MFP 2000.

In the case where, for example, the number of values set in the locked mailbox bin number field 3413 is three as illustrated in FIG. 7, the available bin detection portion 2800 subtracts “3” from “5” that is the total number of locked mailbox bins provided in the MFP 2000, so that “2” is obtained as the number of available locked mailbox bins.

The available bin detection portion 2800 then sends the number of available locked mailbox bins thus obtained to the optimum printing determination portion 2700.

Responding to this, the optimum printing determination portion 2700 compares the number of available locked mailbox bins received from the available bin detection portion 2800 with the value in the available bin threshold field 3313 of the corresponding print level (Step S160).

If the number of available locked mailbox bins received from the available bin detection portion 2800 is equal to or less than the value in the available bin threshold field 3313 of the print level (Step S160: No), then the optimum printing determination portion 2700 determines that the print job 3010 is to be treated as a password-protected print job, and informs the control portion 2100 of the fact.

In contrast, if the number of available locked mailbox bins received from the available bin detection portion 2800 is more than the value in the available bin threshold field 3313 of print level (Step S160: Yes), then the optimum printing determination portion 2700 determines that the print job 3010 is to be treated as a locked mailbox bin print job, and informs the control portion 2100 of the fact.

If receiving the information that the print job 3010 is to be treated as a password-protected print job, then the control portion 2100 reads out, from the print job storage portion 3000, the print job 3010 corresponding to the job number informed by the print job receiving portion 2200, and stores the print job 3010 in the password-protected print job storage portion 3100 (Step S190). Further, the control portion 2100 adds a record to the secure job management table 3410. To be specific, the control portion 2100 adds a record having the informed job number set in the print job number field 3411, and having “YES” set in the password-protected printing field 3412.

On the other hand, if receiving the information that the print job 3010 is to be treated as a locked mailbox bin print job, then the control portion 2100 reads out, from the print job storage portion 3000, the print job 3010 corresponding to the job number informed by the print job receiving portion 2200, sends the print job 3010 to the print process portion 2500, and requests the same to perform printing based on the print job 3010 and output the printed material to a locked mailbox bin. At this time, the control portion 2100 refers to the locked mailbox bin number field 3413 of the secure job management table 3410, and informs the print process portion 2500 of the sequential number of the available locked mailbox bin.

Further, the control portion 2100 adds a record to the secure job management table 3410. To be specific, the control portion 2100 adds a record having the informed job number set in the print job number field 3411, “NO” set in the password-protected printing field 3412, and the sequential number of the available locked mailbox bin, which has been sent to the print process portion 2500, set in the locked mailbox bin number field 3413.

Upon receiving the request, the print process portion 2500 performs printing onto paper based on the image data 3012 of the received print job 3010, and instructs the locked mailbox bin output portion 2550 to output the printed material (Step S200). At this time, the print process portion 2500 informs the locked mailbox bin output portion 2550 of the sequential number of the available locked mailbox bin received from the control portion 2100.

Responding to this, the locked mailbox bin output portion 2550 outputs the printed material to the locked mailbox bin corresponding to the received sequential number among the locked mailbox bin 20i (Step S210).

The following is a description of steps as to how a user obtains a printed material from the MFP 2000, with reference to FIG. 14.

FIG. 14 is a flowchart illustrating an example of printed material acquisition processing performed by the MFP 2000.

The user operates the user terminal 1000 to give a print command, and then goes to a place where the MFP 2000 is installed in order to obtain the printed material.

The user confirms that the log-on screen 2310 (see FIG. 8) appears on the operational panel 20f of the MFP 2000. The user then enters a user name and a password on the log-on screen 2310, and presses the “OK” button.

The log-on information obtaining portion 2300 obtains the user name and the password thus entered, sends the obtained user name and password to the log-on information authentication portion 2400, and requests the log-on information authentication portion 2400 to perform authentication of the user name and the password (Step S300).

Responding to this, the log-on information authentication portion 2400 searches for the user name and the password for which the authentication is requested in the user name field 3211 and the password field 3212 of the user information 3210 stored in the user information storage portion 3200. If the user name and the password are registered in the fields of the user information 3210, then the log-on information authentication portion 2400 sends, to the log-on information obtaining portion 2300, a result indicating that the authentication is successful. If the user name and the password are not registered therein, then the log-on information authentication portion 2400 sends, to the log-on information obtaining portion 2300, a result indicating that the authentication fails.

If the result indicates that the authentication fails (Step S310: Fail), then the log-on information obtaining portion 2300 displays the log-on screen 2310 on the operational panel 20f and finishes the process.

If the result indicates that the authentication is successful (Step S310: Successful), then the log-on information obtaining portion 2300 sends the user name and the password to the control portion 2100.

Responding to this, the control portion 2100 displays the print job list screen 2110 on the operational panel 20f.

Specifically, the control portion 2100 searches in the password-protected print job storage portion 3100 for print jobs of which each of the control information 3011 specifies the same user name and password as those entered on the log-on screen 2310. The control portion 2100 then creates a list of the print jobs found by the search, and displays the list.

The user specifies a document to be printed on the print job list screen 2110, which displays the list of the print jobs, and presses the “OK” button.

When detecting that the document, i.e., the print job, has been specified (Step S320), the control portion 2100 refers to the secure job management table 3410, and determines whether the specified print job is a password-protected print job or a locked mailbox bin print job (Step S330).

Specifically, the control portion 2100 refers to the secure job management table 3410, particularly to, the password-protected printing field 3412 of a record corresponding to the print job number of the print job specified on the print job list screen 2110. If “YES” is indicated in the password-protected printing field 3412, then the control portion 2100 determines that the specified print job is a password-protected print job. Otherwise, the control portion 2100 determines that the specified print job is a locked mailbox bin print job.

In the case where the control portion 2100 determines that the specified print job is a password-protected print job (Step S330: Yes), the control portion 2100 displays the message window 2130 (see FIG. 11) (Step S340).

The control portion 2100 then reads out the specified print job from the password-protected print job storage portion 3100 (Step S350), and requests the print process portion 2500 to perform printing based on the specified print job. At this time, the print process portion 2500 is requested to direct the printed material to the regular mailbox bin output portion 2510.

After that, the control portion 2100 deletes, from the secure job management table 3410, the record corresponding to the print job number of the specified print job.

Upon receiving the request, the print process portion 2500 performs printing onto paper based on the image data 3012 of the print job 3010, and instructs the regular mailbox bin output portion 2510 to output the printed material (Step S360).

Responding to this, the regular mailbox bin output portion 2510 outputs the printed material to the regular mailbox bin 2001 (Step S370).

On the other hand, in the case where the control portion 2100 determines that the specified print job is a locked mailbox bin print job (Step S330: No), the control portion 2100 displays the message window 2120 (see FIG. 10) for informing the user of the sequential number of the locked mailbox bin to which the printed material has been outputted (Step S380).

To be specific, the control portion 2100 refers to the secure job management table 3410, particularly to, the locked mailbox bin number field 3413 of a record corresponding to the print job number of the print job specified on the print job list screen 2110, and obtains the sequential number of the locked mailbox bin to which the printed material has been outputted.

After displaying the message window 2120, the control portion 2100 unlocks the locked mailbox bin to which the printed material has been outputted (Step S390).

The user opens the cover of the locked mailbox bin corresponding to the sequential number shown in the message window 2120, and to remove the printed material therefrom.

After unlocking the locked mailbox bin, the control portion 2100 deletes, from the secure job management table 3410, the record corresponding to the print job number of the specified print job.

After performing the process for the specified print job, the control portion 2100 detects operation performed by the user through the operational panel 20f. If detecting that the user performs operation for returning to the log-on screen 2310 (Step S392: End), then the control portion 2100 displays the log-on screen 2310 on the operational panel 20f. If detecting that the user gives other instructions (Step S392: Other instructions), then the control portion 2100 performs processes accordingly (Step S394).

### Second Embodiment

In the first embodiment, a determination is made that a print job is regarded as a password-protected print job if a print quantity based on the print job is equal to or less than a predetermined value (the value in the quantity threshold field 3312 of the print level information 3310).

The second embodiment involves setting a plurality of thresholds each of which defines a predetermined value used for making such a determination, and determining whether a print job is regarded as a password-protected print job or a locked mailbox bin print job, which implements a precise determination.

The below description of the second embodiment focuses on the points that differ from the first embodiment. As to the other points, the MFP 2000 of the second embodiment is the same as that of the first embodiment.

Specifically, unlike the print level information 3310 (see FIG. 6) used in the first embodiment, print level information 3320 of the second embodiment stored in the level information storage portion 3300 has two quantity thresholds.

FIG. 15 is a diagram illustrating an example of the configuration and details of the print level information 3320.

The print level information 3320 includes the fields of “print level” 3311, “first quantity threshold” 3321, “second quantity threshold” 3322, and “available bin threshold” 3313.

The print level field 3311 indicates a priority that a print job is to be treated as a locked mailbox bin print job.

Each of the first quantity threshold field 3321 and the second quantity threshold field 3322 indicates a threshold of a quantity of a printed material.

The available bin threshold field 3313 indicates a threshold of the number of available bins which is the number of available locked mailbox bins.

The two thresholds of a quantity of a printed material are used to make a determination as to whether a print job is to be treated as a locked mailbox bin print job or a password-protected print job. This is different from the case of the first embodiment.

To be specific, among the optimum print processing shown in the flowchart of FIG. 13 according to the first embodiment, a process using a threshold is different from that of the second embodiment.

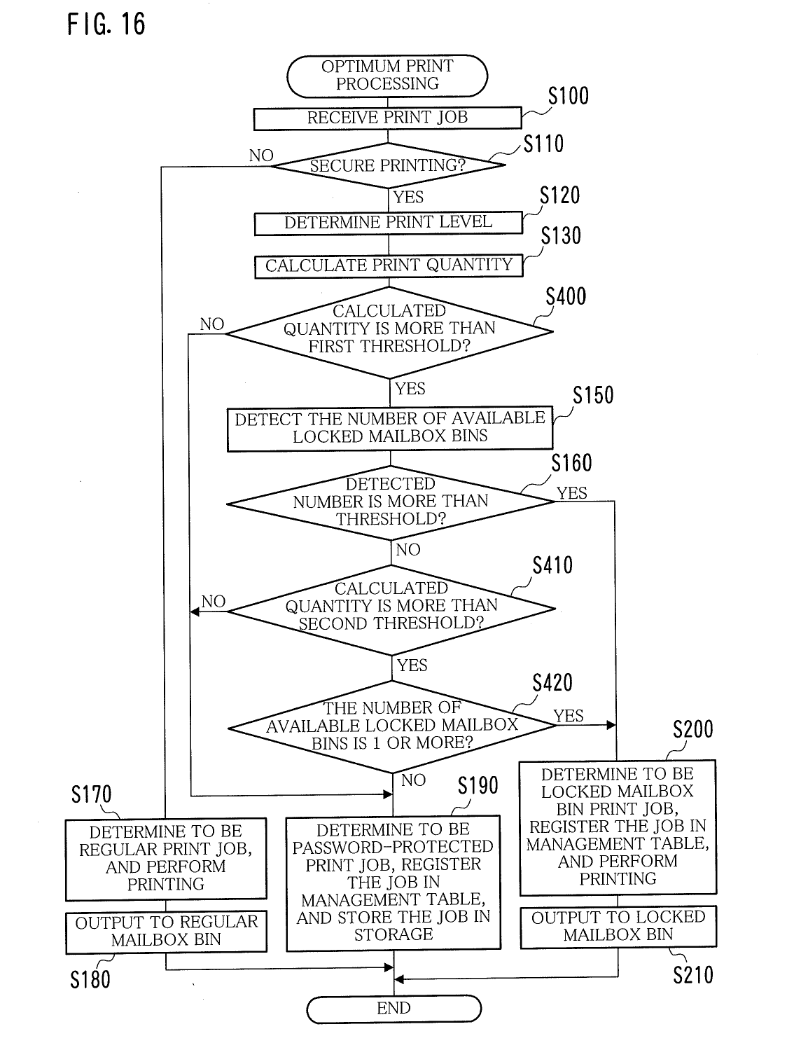

FIG. 16 is a flowchart illustrating an example of optimum print processing according to the second embodiment.

The processing shall be described, focusing on the differences between the flowchart of FIG. 16 of the second embodiment and the flowchart of FIG. 13 of the first embodiment. Referring to FIGS. 13 and 16, processes with the same step numbers have the same contents to be processed.

Thus, the following description focuses on the processes of Step S400, Step S410, and Step S420.

The user operates the user terminal 1000 to transmit the print job 3010 (see FIG. 12) to the MFP 2000.

The print job receiving portion 2200 of the MFP 2000 receives the print job 3010 transmitted by the user terminal 1000 (Step S100). The control portion 2100 determines whether a print job corresponding to a job number informed by the print job receiving portion 2200 is a regular print job or a secure print job (Step S110).

If determining that the print job is a regular print job (Step S110: No), then the control portion 2100 requests the print process portion 2500 to perform printing. Upon receiving the request, the print process portion 2500 performs printing onto paper based on the image data 3012 of the print job 3010, and instructs the regular mailbox bin 2001 (see FIG. 2) to output the printed material thereto (Step S170 and Step S180).

On the other hand, if determining that the print job is a secure print job (Step S110: Yes), then the control portion 2100 requests the optimum printing determination portion 2700 to determine whether the secure print job is to be treated as a password-protected print job or a locked mailbox bin print job. At this time, the control portion 2100 sends, to the optimum printing determination portion 2700, the job number received from the print job receiving portion 2200.

Upon receiving the request, the optimum printing determination portion 2700 refers to a print job 3010 stored in the print job storage portion 3000, and reads out a user name and a password from the print job 3010. Note that the print job 3010 to be referred to is a print job corresponding to the job number received from the print job receiving portion 2200.

The optimum printing determination portion 2700 subsequently refers to the user information 3210 and the user level information 3220 stored in the user information storage portion 3200, and determines a print level (Step S120). It is assumed that the print level thus determined is stored in a work memory.

After that, the optimum printing determination portion 2700 requests the print quantity calculation portion 2600 to calculate a print quantity based on the print job 3010. At this time, the optimum printing determination portion 2700 sends the job number to the print quantity calculation portion 2600.

Responding to this, the print quantity calculation portion 2600 refers to a print job 3010 stored in the print job storage portion 3000, and calculates a print quantity for a case in which printing is performed based on the print job 3010 (Step S130). Note that the print job 3010 to be referred to is a print job corresponding to the job number received from the optimum printing determination portion 2700.

The print quantity calculation portion 2600 then sends the print quantity thus calculated to the optimum printing determination portion 2700.

Upon receiving the print quantity, the optimum printing determination portion 2700 obtains the two quantity thresholds and the number of available locked mailbox bins corresponding to the print level stored in the work memory. At this time, the optimum printing determination portion 2700 refers to the print level information 3320 stored in the level information storage portion 3300.

Specifically, the optimum printing determination portion 2700 refers to a record having the same print level as that stored in the work memory, and obtains the values in the first quantity threshold field 3321, the second quantity threshold field 3322, and the available bin threshold field 3313 of the record as the two quantity thresholds and the available bin threshold corresponding to the print level.

The optimum printing determination portion 2700 then compares the print quantity received from the print quantity calculation portion 2600 with the value in the first quantity threshold field 3321 of the print level (Step S440).

If the print quantity received from the print quantity calculation portion 2600 is equal to or less than the value in the first quantity threshold field 3321 of the print level (Step S400: No), then the optimum printing determination portion 2700 determines that the print job 3010 is to be treated as a password-protected print job, and informs the control portion 2100 of the fact.

In contrast, if the print quantity received from the print quantity calculation portion 2600 is more than the value in the first quantity threshold field 3321 of the print level (Step S400: Yes), then the optimum printing determination portion 2700 requests the available bin detection portion 2800 to obtain the number of available locked mailbox bins.

Responding to this, the available bin detection portion 2800 refers to the secure job management table 3410 stored in the secure job management table storage portion 3400, and obtains the number of available locked mailbox bins (Step S150).

The available bin detection portion 2800 then sends the number of available locked mailbox bins thus obtained to the optimum printing determination portion 2700.

Responding to this, the optimum printing determination portion 2700 compares the number of available locked mailbox bins received from the available bin detection portion 2800 with the value in the available bin threshold field 3313 of the print level (Step S160).

If the number of available locked mailbox bins received from the available bin detection portion 2800 is more than the value in the available bin threshold field 3313 of the print level (Step S160: Yes), then the optimum printing determination portion 2700 determines that the print job 3010 is to be treated as a locked mailbox bin print job, and informs the control portion 2100 of the fact.

In contrast, if the number of available locked mailbox bins received from the available bin detection portion 2800 is equal to or less than the value in the available bin threshold field 3313 of the print level (Step S160: No), then the optimum printing determination portion 2700 compares the print quantity received from the print quantity calculation portion 2600 with the value in the second quantity threshold field 3322 of the print level (Step S410).

If the print quantity received from the print quantity calculation portion 2600 is equal to or less than the value in the second quantity threshold field 3322 of the print level (Step S410: No), then the optimum printing determination portion 2700 determines that the print job 3010 is to be treated as a password-protected print job, and informs the control portion 2100 of the fact.

In contrast, if the print quantity received from the print quantity calculation portion 2600 is more than the value in the second quantity threshold field 3322 of the print level (Step S410: Yes), then the optimum printing determination portion 2700 determines whether the number of available locked mailbox bins, received from the available bin detection portion 2800, is one or more, i.e., whether or not there is availability of locked mailbox bins (Step S420).

If the number of available locked mailbox bins, received from the available bin detection portion 2800, is one or more (Step S420: Yes), then the optimum printing determination portion 2700 determines that the print job 3010 is to be treated as a locked mailbox bin print job, and informs the control portion 2100 of the fact.

In contrast, if none of the locked mailbox bins are available (Step S420: No), then the optimum printing determination portion 2700 determines that the print job 3010 is to be treated as a password-protected print job, and informs the control portion 2100 of the fact.

If receiving the information that the print job 3010 is to be treated as a password-protected print job, then the control portion 2100 reads out, from the print job storage portion 3000, the print job 3010 corresponding to the job number informed by the print job receiving portion 2200, and stores the print job 3010 in the password-protected print job storage portion 3100 (Step S190). Further, the control portion 2100 adds, to the secure job management table 3410, a record corresponding to the print job 3010, i.e., the password-protected print job.

On the other hand, if receiving the information that the print job 3010 is to be treated as a locked mailbox bin print job, then the control portion 2100 reads out, from the print job storage portion 3000, the print job 3010 corresponding to the job number informed by the print job receiving portion 2200, sends the print job 3010 to the print process portion 2500, and requests the same to perform printing based on the print job 3010 and output the printed material to a locked mailbox bin. At this time, the control portion 2100 refers to the locked mailbox bin number field 3413 of the secure job management table 3410, and sends, to the print process portion 2500, the sequential number of the available locked mailbox bin.

Further, the control portion 2100 adds, to the secure job management table 3410, a record corresponding to the print job 3010, i.e., the locked mailbox bin print job.

Upon receiving the request, the print process portion 2500 performs printing onto paper based on the image data 3012 of the received print job 3010, and instructs the locked mailbox bin output portion 2550 to output the printed material (Step S200). At this time, the print process portion 2500 sends, to the locked mailbox bin output portion 2550, the sequential number of the locked mailbox bin received from the control portion 2100.

Responding to this, the locked mailbox bin output portion 2550 outputs the printed material to the locked mailbox bin corresponding to the received sequential number among the locked mailbox bin 20i (Step S210).

In the second embodiment, a plurality of thresholds of a print quantity are provided, and the thresholds are used to make a determination as to whether a received print job is regarded as a password-protected print job or a locked mailbox bin print job. Thus, such a determination is made precisely.

Although the embodiments of the present invention have been described above, the present invention is not limited thereto. The following arrangement is possible.

1) In the embodiments described above, a print level (see FIGS. 5A and 5B) is defined depending on a title of a user, which is one of attributes of the user. Instead, however, a print level may be defined depending on another attribute of the user.

For example, a print level to be given to a user operating the user terminal 1000 may be defined in accordance with the distance between the user terminal 1000 and the MFP 2000.

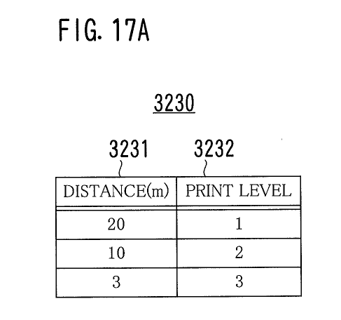

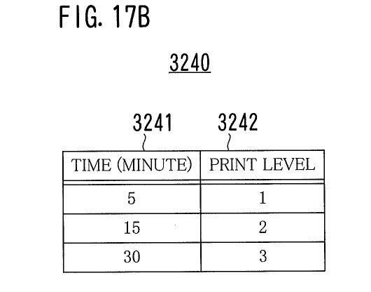

FIG. 17A shows an example of user level information 3230 for such a case. The user level information 3230 includes the fields of “distance” 3231 and “print level” 3232.

Referring to the user level information 3230 of FIG. 17A, a user operating a user terminal that is installed farther away from the MFP 2000 is given a print level having a higher priority. This is because shorter waiting time is set for a user who needs time to reach the place where the MFP is installed to pick up a printed material.

In the case where, for example, the distance between the user terminal 1000 and the MFP 2000 is 3 meters or shorter, the print level “3” is set for a user of the user terminal 1000.

Another configuration is possible in which a print level to be given to a user is defined in accordance with the time from when the user operates the user terminal 1000 to transmit a print job until the user obtains, from the MFP 2000, a printed material based on the print job.

FIG. 17B shows an example of user level information 3240 for such a case. The user level information 3240 includes the fields of “time” 3241 and “print level” 3242.

Referring to the user level information 3240 of FIG. 17B, a user who takes longer time from when he/she transmits a print job until he/she obtains the printed material is given a print level having a lower priority. This is because if a printed material outputted to a locked mailbox bin is left unremoved therefrom for a long time, it is impossible to use the locked mailbox bin effectively.

For example, the print level “1” is assigned to a user who takes time from when he/she transmits a print job until he/she obtains the printed material from the MFP 2000. In such a case, for example, the MFP 2000 stores therein, on a user-by-user basis, a history of records of the time taken from when a print job is transmitted until a printed material corresponding to the print job is obtained, and determines a print level based on the average of the records of the time.

To be specific, for example, information indicating the time when a print job has been transmitted is incorporated into the control information 3011 of the print job 3010. The control portion 2100 of the MFP 2000 stores, therein, as acquisition time, the time from when a print job has been transmitted, which is contained in the print job 3010, until a user who has acquired a printed material corresponding to the print job. In the case of a print job determined to be a locked mailbox bin print job, the time at which a locked mailbox bin as the output destination of the printed material has been unlocked is regarded as the time at which a user has acquired a printed material corresponding to the print job. In the case of a print job determined to be a password-protected print job, the time at which printing starting in response to successful authentication of a user has been completed is regarded as the time at which a user has acquired a printed material corresponding to the print job. The control portion 2100 stores therein, as a history, records of the acquisition time on a user-by-user basis, calculates the average of the records of the acquisition time appropriately, e.g., calculates on Monday the average of the records for the preceding week, and updates values in the print level field. Alternatively, the control portion 2100 is configured to update values in the print level field every time when the acquisition time is calculated, depending on the calculated acquisition time, instead of storing records of the acquisition time as a history.

2) In the embodiments discussed above, when a user logs onto the MFP, authentication is performed based on a user name and a password. However, another authentication method is applicable. For example, authentication may be performed based on a card number of an IC card or biometric information such as a fingerprint or vein patterns.

3) The whole or a part of the individual elements of the secure printing system shown in, for example, FIG. 4 may be realized in the form of a one-chip integrated circuit or multi-tip integrated circuits.

4) The whole or a part of the individual elements in the secure printing system shown in, for example, FIG. 4 may be realized by a computer program, or may be implemented in any other formats.

In the case of a computer program, a computer is preferably caused to load the computer program written onto a recording medium such as a memory card or a CD-ROM, and to execute the computer program. Alternatively, a computer is preferably caused to download a computer program via a network and to execute the computer program.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. An image forming apparatus including at least one locked mailbox bin, the image forming apparatus comprising:
a job receiving portion that receives a print job;
a print quantity calculation portion that calculates a print quantity for a case in which the print job thus received is executed;
a storage portion that stores, therein, the print job based on which printing is executed in response to operation for authenticating a user; and
a controller that performs control such that,
if the print quantity for the print job calculated by the print quantity calculation portion is more than a predetermined quantity, printing based on the print job is executed with the locked mailbox bin designated as an output destination of a printed material, and,
if the print quantity for the print job calculated by the print quantity calculation portion is equal to or less than the predetermined quantity, the storage portion stores the print job therein.

2. The image forming apparatus according to claim 1,
wherein
said at least one locked mailbox bin includes a plurality of locked mailbox bins,
the image forming apparatus further comprises an available mailbox bin detection portion that detects, among the plurality of locked mailbox bins, a number of available locked mailbox bins, and
the controller performs control such that,
if the number of available locked mailbox bins detected by the available mailbox bin detection portion is more than a predetermined value, and if the print quantity for the print job calculated by the print quantity calculation portion is more than the predetermined quantity, printing based on the print job is executed with the locked mailbox bin designated as the output destination, and,
if the number of available locked mailbox bins detected by the available mailbox bin detection portion is equal to or less than the predetermined value, or if the print quantity for the print job calculated by the print quantity calculation portion is equal to or less than the predetermined quantity, the storage portion stores the print job therein.

3. The image forming apparatus according to claim 2,
wherein
the print job received by the job receiving portion includes user identification information for identifying a user who has transmitted the print job,
the image forming apparatus further comprises a level storage portion that stores, therein, print level information in association with the user identification information, the print level information including a print quantity and the number of available locked mailbox bins, and
the controller sets, as the predetermined quantity, the print quantity included in the print level information that is stored in the level storage portion in association with the user identification information included in the print job, further sets, as the predetermined value, the number of available locked mailbox bins included in the print level information, and controls execution of printing based on the print job.

4. The image forming apparatus according to claim 3, wherein the level storage portion stores, therein, the print level information in association with the user identification information included in the print job based on an attribute of the user identified by the user identification information.

5. The image forming apparatus according to claim 4, wherein the attribute of the user is a managerial title of the user.

6. The image forming apparatus according to claim 4, wherein the attribute of the user is a distance between the image forming apparatus and a device by means of which the user performs operation for transmitting the print job.

7. The image forming apparatus according to claim 4,
wherein
the print job received by the job receiving portion further includes transmission time information for identifying time at which the print job has been transmitted,
the image forming apparatus further comprises an obtaining portion that determines acquisition time measured between the time identified by the transmission time information included in the print job and time at which the user has obtained a printed material for the print job,
if the print job is executed with the locked mailbox bin designated as the output destination, the obtaining portion determines the acquisition time for the print job by regarding, as the time at which the user has obtained a printed material for the print job, time at which the locked mailbox bin as the output destination is unlocked, and, if the print job is stored in the storage portion, the obtaining portion determines the acquisition time for the print job by regarding, as the time at which the user has obtained a printed material for the print job, time at which printing based on the print job is completed, and
the attribute of the user is the acquisition time for the print job including the user identification information for identifying the user.

8. The image forming apparatus according to claim 1,
wherein
said at least one locked mailbox bin includes a plurality of locked mailbox bins,
the image forming apparatus further comprises an available mailbox bin detection portion that detects, among the plurality of locked mailbox bins, a number of available locked mailbox bins, and
the controller performs control such that
if the number of available locked mailbox bins detected by the available mailbox bin detection portion is more than a predetermined value, and if the print quantity for the print job calculated by the print quantity calculation portion is more than a first predetermined quantity, printing based on the print job is executed with the locked mailbox bin designated as the output destination,
if the print quantity for the print job calculated by the print quantity calculation portion is equal to or less than the first predetermined quantity, the storage portion stores the print job therein,
if the number of available locked mailbox bins detected by the available mailbox bin detection portion is equal to or less than the predetermined value, and if the print quantity for the print job calculated by the print quantity calculation portion is more than a second predetermined quantity that is greater than the first predetermined quantity, printing based on the print job is executed with the locked mailbox bin designated as the output destination, and,
if the print quantity for the print job calculated by the print quantity calculation portion is equal to or less than the second predetermined quantity, the storage portion stores the print job therein.

9. The image forming apparatus according to claim 1, further comprising a detection portion that detects a user command for specifying a print job,
wherein the controller performs control such that,
if the print job specified in the user command detected by the detection portion is a print job executed with the locked mailbox bin designated as the output destination, a message indicating the locked mailbox bin as the output destination is displayed, and,
if the print job specified in the user command detected by the detection portion is a print job stored in the storage portion, the print job is executed and a message indicating that printing based on the print job is executed is displayed.

10. A computer-readable storage medium storing thereon a computer program used in an image forming apparatus including a locked mailbox bin, the computer program causing the image forming apparatus to perform a print process comprising:
a job receiving step of receiving a print job;
a print quantity calculation step of calculating a print quantity for a case in which the print job thus received is executed;
a storing step of storing, in a storage portion, the print job based on which printing is executed in response to operation for authenticating a user; and
a control step of performing control such that,
if the print quantity for the print job calculated in the print quantity calculation step is more than a predetermined quantity, printing based on the print job is executed with the locked mailbox bin designated as an output destination of a printed material, and,
if the print quantity for the print job calculated in the print quantity calculation step is equal to or less than the predetermined quantity, the print job is stored in the storage portion.
